(19) United States
(12) Patent Application Publication
(10) Pub. No.: US 2025/0317767 A1
(43) Pub. Date: Oct. 9, 2025

(54) FAULT PROCESSING METHOD AND DEVICE, AND COMPUTER-READABLE STORAGE MEDIUM

(71) Applicant: ZTE CORPORATION, Shenzhen (CN)

(72) Inventors: Leilei SIMA, Shenzhen (CN); Shan WANG, Shenzhen (CN); Chunhui LI, Shenzhen (CN)

(21) Appl. No.: 18/873,094

(22) PCT Filed: Jun. 16, 2023
(86) PCT No.: PCT/CN2023/100795

§ 371 Date: Dec. 9, 2024

(30) Foreign Application Priority Data
Jun. 17, 2022 (CN) 202210717343.4

(51) Int. Cl. H04W 24/08; H04W 24/04

(52) U.S. Cl. CPC H04W 24/08; H04W 24/04

(57) ABSTRACT

The present disclosure provides a fault processing method and device, and a computer-readable storage medium. The method may include: acquiring an alarm type of a chip including an alarm indicating that a fault of the chip is self-repairable and an alarm indicating that the fault of the chip is not self-repairable; when the alarm type indicates that the fault of the chip is not self-repairable, retrieving a historical alarm identifier of the chip, and when a historical alarm identifier of the chip is present for N (≥1) times, executing a preset self-repair process; when the chip is still in an abnormal state after the self-repair process has been executed M (≥1) times, determining whether a transceiver system meets a system reset requirement; and when the transceiver system meets the system reset requirement, starting a system reset operation to repair the fault of the chip.

### CROSS-REFERENCE TO RELATED APPLICATION

This application is a national stage filing under 35 U.S.C. § 371 of international application number PCT/CN2023/100795, filed Jun. 16, 2023, which claims priority to Chinese patent application No. 202210717343.4 filed Jun. 17, 2022. The entire contents of these applications are incorporated herein by reference.

### TECHNICAL FIELD

Embodiments of the present disclosure relate to, but not limited to, the technical field of communication, and in particular, to a fault processing method and device, and a computer-readable storage medium.

### BACKGROUND

Most of existing methods for detection and automatic processing of faults in communication devices are designed for system devices such as network management systems and base stations. No scheme has been proposed for detection and correction of a fault in a transceiver chip in an Active Antenna Unit (AAU)/Remote Radio Unit (RRU), resulting in inefficient operation and maintenance of transceiver chips and consequently long impact of the fault and high labor costs for maintenance.

### SUMMARY

The following is a summary of the subject matter set forth in this description. This summary is not intended to limit the scope of protection of the claims.

Embodiments of the present disclosure provide a fault processing method and device, and a computer-readable storage medium.

In accordance with a first aspect of the present disclosure, an embodiment provides a fault processing method, which may include: acquiring an alarm type of a chip, where the alarm type includes an alarm indicating that a fault of the chip is self-repairable and an alarm indicating that the fault of the chip is not self-repairable; in response to determining that the alarm type indicates that the fault of the chip is not self-repairable, retrieving a historical alarm identifier of the chip, and in response to identifying that a historical alarm identifier of the chip for N times, executing a preset self-repair process, where N is an integer greater than or equal to 1; in response to determining that the chip is still in an abnormal state after the self-repair process has been executed M times, determining whether a transceiver system meets a system reset requirement, where M is an integer greater than or equal to 1; and in response to the transceiver system meeting the system reset requirement, starting a system reset operation to repair the fault of the chip.

In accordance with a second aspect of the present disclosure, an embodiment provides a base station, which may include: a memory, a processor, and a computer program stored in the memory and executable by the processor, where the computer program, when executed by the processor, causes the processor to implement the fault processing method in accordance with the first aspect.

In accordance with a third aspect of the present disclosure, an embodiment provides a fault processing apparatus, which may include: a memory, a processor, and a computer program stored in the memory and executable by the processor, where the computer program, when executed by the processor, causes the processor to implement the fault processing method in accordance with the first aspect.

In accordance with a fourth aspect of the present disclosure, an embodiment provides a computer-readable storage medium, storing a computer-executable program which, when executed by a computer, causes the computer to implement the fault processing method in accordance with the first aspect.

Additional features and advantages of the present disclosure will be set forth in the description which follows, and in part will be obvious from the description, or may be learned by the practice of the present disclosure. The objects and other advantages of the present disclosure can be realized and obtained by the structures particularly pointed out in the description, claims and drawings.

### BRIEF DESCRIPTION OF DRAWINGS

The drawings are provided for a further understanding of the technical schemes of the present disclosure, and constitute a part of the description. The drawings and the embodiments of the present disclosure are used to illustrate the technical schemes of the present disclosure, but are not intended to limit the technical schemes of the present disclosure.

FIG. 1 is a main flowchart of a fault processing method according to an embodiment of the present disclosure;

FIG. 2 is a detailed flowchart of a fault processing method according to an embodiment of the present disclosure;

FIG. 3 is another detailed flowchart of a fault processing method according to an embodiment of the present disclosure;

FIG. 4 is another detailed flowchart of a fault processing method according to an embodiment of the present disclosure;

FIG. 5 is another detailed flowchart of a fault processing method according to an embodiment of the present disclosure;

FIG. 6 is another detailed flowchart of a fault processing method according to an embodiment of the present disclosure;

FIG. 7 is a flowchart of fault diagnosis and output according to an embodiment of the present disclosure;

FIG. 8 is a schematic structural diagram of a base station according to an embodiment of the present disclosure; and

FIG. 9 is a schematic structural diagram of a fault processing device according to an embodiment of the present disclosure.

### DETAILED DESCRIPTION

To make the objects, technical schemes, and advantages of the present disclosure clear, the present disclosure is described in further detail in conjunction with accompanying drawings and examples. It should be understood that the specific embodiments described herein are merely used for illustrating the present disclosure, and are not intended to limit the present disclosure.

It should be understood that in the description of the embodiments of the present disclosure, the term “plurality of” (or multiple) means at least two, the term such as “greater than”, “less than”, “exceed” or variants thereof prior to a number or series of numbers is understood to not include the number adjacent to the term. The term “at least” prior to a number or series of numbers is understood to include the number adjacent to the term “at least”, and all subsequent numbers or integers that could logically be included, as clear from context. If used herein, the terms such as “first” and “second” are merely used for distinguishing technical features, and are not intended to indicate or imply relative importance, or implicitly point out the number of the indicated technical features, or implicitly point out the order of the indicated technical features.

Most of existing methods for detection and automatic processing of faults in communication devices are designed for system devices such as network management systems and base stations. No scheme has been proposed for detection and correction of a fault in a transceiver chip in an AAU/RRU, resulting in inefficient operation and maintenance of transceiver chips and consequently long impact of the fault and high labor costs for maintenance.

To solve the above technical problems, embodiments of the present disclosure provide a fault processing method and device, and a computer-readable storage medium to acquire an alarm type of a chip. In some embodiments of the present disclosure, the alarm type may include: (1) an alarm indicating that a fault of the chip is self-repairable and (2) an alarm indicating that the fault of the chip is not self-repairable. In the embodiments of the present disclosure, when it is determined that the alarm type indicates that the fault of the chip is not self-repairable, a historical alarm identifier of the chip is retrieved. When it is identified that a historical alarm identifier of the chip is present for N times, a preset self-repair process is executed, where N is an integer greater than or equal to 1. When it is determined that the chip is still in an abnormal state after the self-repair process has been executed M times, it is determined whether a transceiver system meets a system reset requirement, where M is an integer greater than or equal to 1. When the transceiver system meets the system reset requirement, a system reset operation is started to repair the fault of the chip. Based on this, the present disclosure can intelligently implement fault information detection and fault recovery while minimizing the impact on normal operation of the transceiver system, providing effective information for engineers to analyze faults. The present disclosure has the advantages of high accuracy of fault information and short fault recovery time, thereby improving the timeliness of product fault correction. The present disclosure can achieve intelligent operation and maintenance during the use of the transceiver system, improve production and maintenance efficiency, shorten the impact of the fault, and reduce labor costs for maintenance.

As shown in FIG. 1, FIG. 1 is a flowchart of a fault processing method according to an embodiment of the present disclosure. The fault processing method includes, but not limited to, the following steps.

In a step of S101, an alarm type of a chip is acquired. The alarm type includes an alarm indicating that a fault of the chip is self-repairable and an alarm indicating that the fault of the chip is not self-repairable.

In a step of S102, when it is determined that the alarm type indicates that the fault of the chip is not self-repairable, a historical alarm identifier of the chip is retrieved, and when it is identified that a historical alarm identifier of the chip is present for N times, a preset self-repair process is executed, where N is an integer greater than or equal to 1.

In a step of S103, when it is determined that the chip is still in an abnormal state after the self-repair process has been executed M times, it is determined whether a transceiver system meets a system reset requirement, where M is an integer greater than or equal to 1.

In a step of S104, when the transceiver system meets the system reset requirement, a system reset operation is started to repair the fault of the chip.

In an example embodiment, the method can be applied to processing of faults in a transceiver chip in an AAU or RRU.

In an example embodiment, a fault pre-analysis may be performed before an internal fault detection of the chip. Firstly, functions of the transceiver chip in the transceiver system and modules in the chip and impact of faults of the chip and its modules on various indicators and functions of the system are analyzed. Next, an operational status information acquisition method and a fault state determining condition of each chip module are determined. Then, priorities of various indicators and functions of the system are determined, so that fault statuses of the chip modules are processed subsequently in a descending order of the priorities.

In an example embodiment, a fault detection module may be integrated in the transceiver chip, to acquire an alarm state of each module of the chip according to the priorities determined in the fault analysis, and determine an alarm type. Alarms of the chips are classified into two alarm types: an alarm indicating that a fault of the chip is self-repairable and an alarm indicating that the fault of the chip is not self-repairable.

In an example embodiment, when it is determined that the alarm type indicates that the fault of the chip is self-repairable, the fault of the chip can be directly self-repaired.

In an example embodiment, a fault recovery module may further be integrated in the transceiver chip to automatically process a self-repairable fault of the chip. If an alarm from the fault detection module indicates that the fault of the chip is self-repairable, the fault recovery module self-repairs the fault of the chip. For example, if an alarm is triggered because a digital power of a transmit channel is abnormal and exceeds a set value, the fault self-repair module decreases the transmit power to an abnormal set value of 1 to protect a radio frequency emission component, and latches an alarm indication identifier through a register, but does not indicate an alarm identifier to an external system through a hardware Input/Output (IO) interface. When the fault recovery module learns from the fault detection module that this alarm disappears, the fault self-repair module changes the transmit power back to a normal set value of 2 to restore the transmit power.

In an example embodiment, the fault recovery module in the transceiver chip acquires the alarm type from the fault detection module. If the alarm indicates that the fault of the chip is not self-repairable, such as a clock type, power type, or interface type alarm, the chip saves key operational status information to a black box module. The key operational status information includes a chip software/hardware version number, clock, power state, SERDES and JESD204 interface states, a calibration algorithm, and an initial calibration state, and indicates an alarm identifier to the system through a hardware IO interface.

In an example embodiment, the fault detection module retrieves alarm identifier of all chips in the transceiver system through the hardware IO interface. When a historical alarm identifier is retrieved in a chip, information in a black box module of the chip is first read through an instruction and saved to a device Read-Only Memory (ROM). This process prevents key fault information of the chip from being overwritten by alarm clearing and exception recovery operations, so as to provide more accurate information for engineers to analyze faults. Then, the system clears historical alarm identifiers of the chip, and the alarm detection module retrieves again a historical alarm identifier in each chip module. This operation is repeated N times (N being an integer greater than or equal to 1), for the purpose of determining whether the chip alarm has become normal. If it is identified that a historical alarm is present in the chip for N times, it is determined that the component is currently in an abnormal state, and an abnormal fault recovery process is executed. It should be noted that the number of times of retrieving a historical alarm identifier of the chip is set to be greater than 1 in order to avoid incorrect detection due to the possibility that the system does not clear historical alarm identifiers of the chip completely, and the risk of incorrect detection can be eliminated by a plurality of successive detections.

In an example embodiment, if the number of times for performing the fault recovery process is less than M (M is an integer greater than or equal to 1), a pre-designed system automatic fault recovery process is executed, and complete operation and log information is saved into the device ROM. It should be noted that the number of times of performing the fault recovery process is set to be greater than or equal to 1 in order to cope with the possibility of failure to correct the fault of the chip, and the success rate of chip recovery can be increased by repeating the recovery process multiple times.

In an example embodiment, the designing principle of the fault recovery process requires not to affect the operational status of other normal chip modules in the system or to minimize the number of affected normal chip modules at first, and then, reduce the time and system resources required by the fault recovery process. For example, if communication of a JESD204 interface of a transceiver chip is abnormal, a link establishment process for a JESD204 link to be used by the chip is initiated again. For another example, if a lock status of a phase-locked loop of a transceiver chip is abnormal, a reset and initialization process for the chip is initiated again, to reconfigure a reference clock and a phase-locked loop module.

In an example embodiment, if the fault recovery process is executed for M times, it is determined that this faulty module cannot be restored to a normal operating state through the pre-designed automatic fault recovery process. Then, it is determined whether the transceiver system meets a system reset requirement. The system reset requirement may be a time period with a small statistical data traffic volume, or a transceiver sleep operation delivered by a network management system. If the system reset requirement is met, the chip enters a reset state to attempt to restart to recover the fault. It should be noted that after the system reset requirement is met, the chip may also enter a system fault diagnosis and reporting process. If the system reset requirement is not met, the system remains in the faulty state, until the system reset requirement is met. Based on this, fault information detection and fault recovery can be intelligently implemented while minimizing the impact on normal operation of the transceiver system.

In an example embodiment, faults of the transceiver system may be classified into various types such as a downlink fault, an uplink fault, a calibration link fault, a power supply fault, a clock fault, etc. Fault information of each module in the fault detection process is acquired, so that it is determined a specific functional branch of the transceiver system to which the current fault belongs, and then a corresponding fault diagnosis process is executed. The fault information of each module acquired in the fault detection process is a fault reported independently by each chip module, and the cause of system fault cannot be directly output, so further comprehensive analysis is needed. Moreover, independent diagnosis processes are designed according to branches in order to reduce the complexity of analysis of complex system fault through the diagnosis process. A more detailed and comprehensive diagnosis process can be designed for each branch without increasing the diagnosis time, thereby improving the efficiency and accuracy of the diagnosis module. The fault diagnosis process of each fault branch saves whole operation and log information to the device ROM, so as to provide comprehensive and accurate information for engineers to analyze faults. After the fault diagnosis process is completed, a fault diagnosis report including a fault branch, a fault chip ID, and a preliminary fault diagnosis cause is output according to the determined functional branch of the transceiver system, and then a fault diagnosis result of the transceiver system is reported to the network management system. Finally, the chip enters the system reset state to attempt to restart the system to recover the fault.

Based on the above, the acquired alarm type of a chip includes an alarm indicating that a fault of the chip is self-repairable, and an alarm indicating that the fault of the chip is not self-repairable. The fault of the chip is self-repaired when it is determined that the alarm type indicates that the fault of the chip is self-repairable. When it is determined that the alarm type indicates that the fault of the chip is not self-repairable, a historical alarm identifier of the chip is retrieved. When it is identified that a historical alarm identifier of the chip is present for N times, a preset self-repair process is executed, where N is an integer greater than or equal to 1. When the chip is still in an abnormal state after the self-repair process has been executed M times, it is determined whether a transceiver system meets a system reset requirement, where M is an integer greater than or equal to 1. When the transceiver system meets the system reset requirement, a system reset operation is started to repair the fault of the chip. Based on this, the present disclosure can intelligently implement fault information detection and fault recovery while minimizing the impact on normal operation of the transceiver system, thereby providing effective information for engineers to analyze faults. The present disclosure has the advantages of high accuracy of fault information and short fault recovery time, thereby improving the timeliness of product fault correction. The present disclosure can achieve intelligent operation and maintenance during the use of the transceiver system, improve production and maintenance efficiency, shorten the impact of the fault, and reduce labor costs for maintenance.

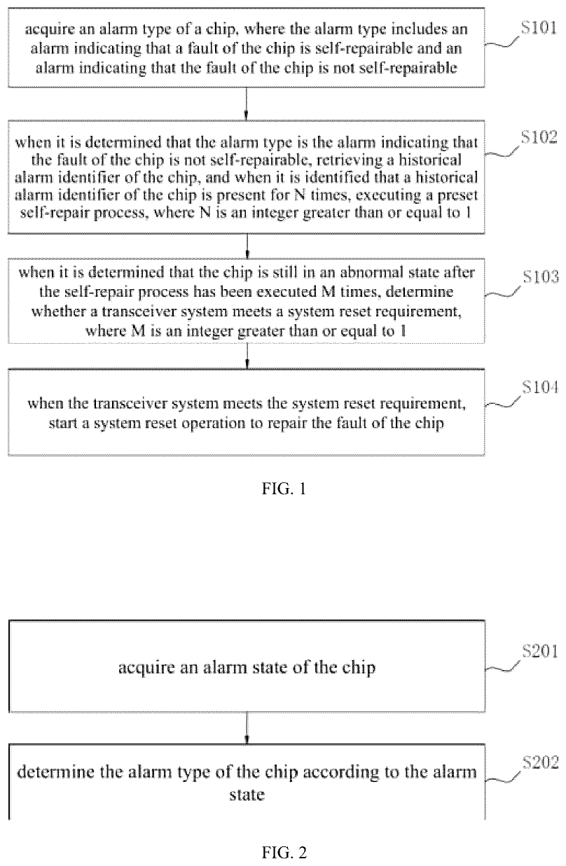

As shown in FIG. 2, the step S101 may include, but not limited to, the following sub-steps.

In a step of S201, an alarm state of the chip is acquired.

In a step of S202, the alarm type of the chip is determined according to the alarm state.

In an example embodiment, the alarm type is determined according to the acquired alarm state of the chip. Alarms of the chips are classified into two alarm types: an alarm indicating that a fault of the chip is self-repairable and an alarm indicating that the fault of the chip is not self-repairable.

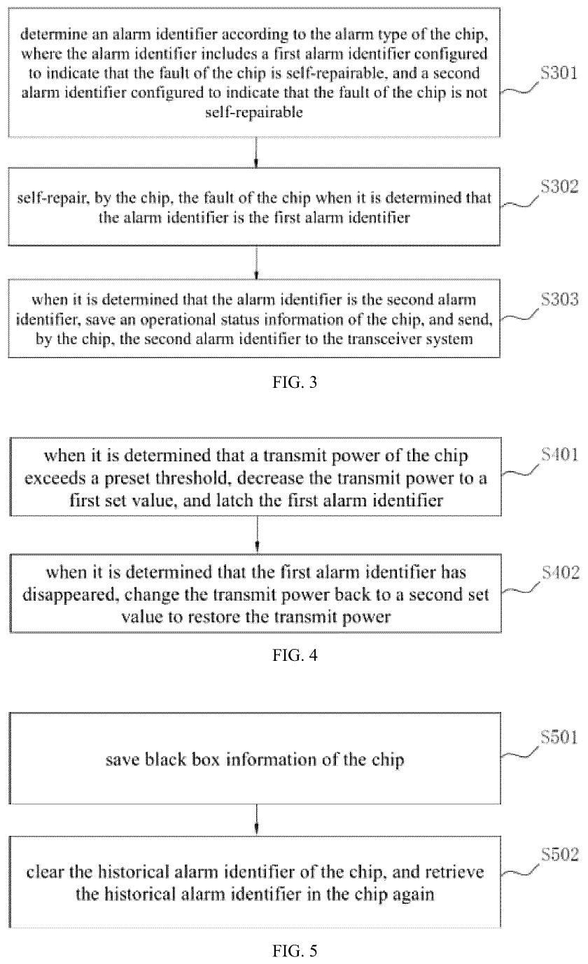

As shown in FIG. 3, after the sub-step S202, the method may further include, but not limited to, the following sub-steps.

In a step of S301, an alarm identifier is determined according to the alarm type of the chip. The alarm identifier includes a first alarm identifier configured to indicate that the fault of the chip is self-repairable, and a second alarm identifier configured to indicate that the fault of the chip is not self-repairable.

In a step of S302, when it is determined that the alarm identifier is the first alarm identifier, the chip self-repairs the fault of the chip.

In a step of S303, when it is determined that the alarm identifier is the second alarm identifier, an operational status information of the chip is saved, and the chip sends the second alarm identifier to the transceiver system.

In an example embodiment, the alarm type of the chip may be identified by an alarm identifier. For example, the alarm identifier may include a first alarm identifier configured to indicate that the fault of the chip is self-repairable, and a second alarm identifier configured to indicate that the fault of the chip is not self-repairable. When it is determined that the alarm identifier is the first alarm identifier indicating that the fault of the chip is self-repairable, the fault recovery module integrated in the chip may automatically recover the fault of the chip. When it is determined that the alarm identifier is the second alarm identifier indicating that the fault of the chip is not self-repairable, such as a clock type, power type, or interface type alarm, the chip saves key operational status information to a black box module. The key operational status information includes a chip software/hardware version number, clock, power state, SERDES and JESD204 interface states, a calibration algorithm, and an initial calibration state, and the chip indicates the alarm identifier to the system through a hardware IO interface.

As shown in FIG. 4, the step S302 may include, but not limited to, the following sub-steps.

In a step of S401, when it is determined that a transmit power of the chip exceeds a preset threshold, the transmit power is decreased to a first set value, and the first alarm identifier is latched.

In a step of S402, when it is determined that the first alarm identifier has disappeared, the transmit power is changed back to a second set value to restore the transmit power.

In an example embodiment, if an alarm is triggered because a transmit power of a transmit chip is abnormal and exceeds a set value, the fault self-repair module decreases the transmit power to an abnormal set value of 1 to protect a radio frequency emission device, and latches an alarm indication identifier through a register, but does not indicate an alarm identifier to an external system through a hardware IO interface. When the fault recovery module learns from the fault detection module that this alarm disappears, the fault self-repair module changes the transmit power back to a normal set value of 2 to restore the transmit power.

As shown in FIG. 5, after the transceiver system meets the system reset requirement, the method further includes, but not limited to, the following sub-steps.

In a step of S501, black box information of the chip is saved.

In a step of S502, the historical alarm identifier of the chip is cleared, and the historical alarm identifier is retrieved in the chip again.

In an example embodiment, when it is detected that a historical alarm identifier is present in a chip, information in a black box module of the chip is firstly read through an instruction and saved to a device ROM. This process prevents key fault information of the chip from being overwritten by alarm clearing and exception recovery operations, so as to provide more accurate information for engineers to analyze faults. Then, the system clears historical alarm identifiers of the chip, and the alarm detection module retrieve a historical alarm identifier in each chip module again. This operation is repeated N times (N is an integer greater than or equal to 1) in order to determine whether the chip alarm has become normal. If it is identified that a historical alarm is present in the chip for N times, it is determined that the chip is currently in an abnormal state, and a fault recovery process is executed.

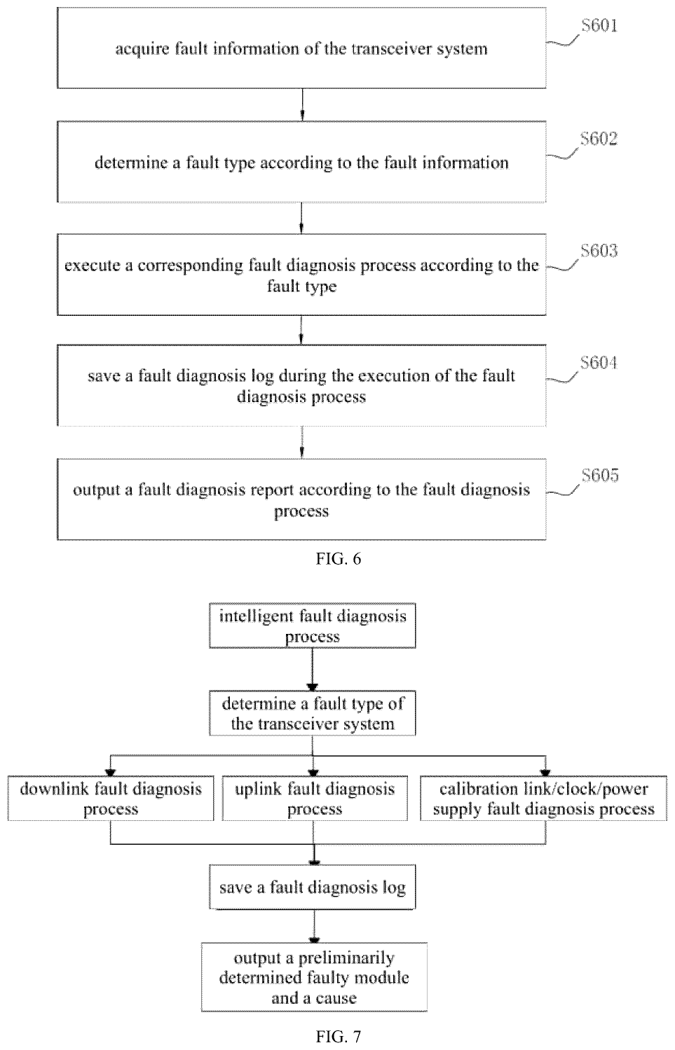

As shown in FIG. 6, after the step S502, the method may further include, but not limited to, the following steps.

In a step of S601, fault information of the transceiver system is acquired.

In a step of S602, a fault type is determined according to the fault information.

In a step of S603, a corresponding fault diagnosis process is executed according to the fault type.

In a step of S604, a fault diagnosis log is saved during the execution of the fault diagnosis process.

In a step of S605, a fault diagnosis report is outputted according to the fault diagnosis process.

In an example embodiment, as shown in FIG. 7, automatic fault diagnosis is performed on the faulty chip module. Faults of the transceiver system may be classified into various types such as a downlink fault, an uplink fault, a calibration link fault, a power supply fault, a clock fault, etc. Fault information of each module in the fault detection process is acquired, so that it is determined a specific functional branch of the transceiver system to which the current fault belongs, and then a corresponding fault diagnosis process is executed. The fault information of each module acquired in the fault detection process is a fault reported independently by each chip module, and the cause of system fault cannot be directly output, so further comprehensive analysis is needed. Moreover, independent diagnosis processes are designed according to branches in order to reduce the complexity of analysis of complex system fault through the diagnosis process. A more detailed and comprehensive diagnosis process can be designed for each branch without increasing the diagnosis time, thereby improving the efficiency and accuracy of the diagnosis module. The fault diagnosis process of each fault branch saves whole complete operation and log information to the completely built ROM, so as to provide comprehensive and accurate information for engineers to analyze faults. After the fault diagnosis process is completed, a fault diagnosis report including a fault branch, a fault chip ID, and a preliminary fault diagnosis cause is output according to the determined functional branch of the transceiver system, and then a fault diagnosis result of the transceiver system is reported to the network management system. Finally, the chip enters the system reset state to attempt to restart the system to recover the fault.

Based on the above, the present disclosure can be applied to automatic detection, processing, and diagnosis of faults of a transceiver chip and a transceiver link after normal startup and during operation of an AAU/RRU system. In addition, the present disclosure can intelligently implement fault information detection, fault recovery, and fault diagnosis and reporting while minimizing the impact on normal operation of the transceiver system, and ensure that the key fault information of each chip module will not be overwritten or lost, thereby providing effective information for engineers to analyze faults. The present disclosure has the advantages of high accuracy of fault information and short fault recovery time, thereby improving the timeliness of product fault diagnosis and reporting. The present disclosure can achieve intelligent operation and maintenance during the use of the transceiver system, improve production and maintenance efficiency, shorten the impact of the fault, and reduce labor costs for maintenance.

As shown in FIG. 8, an embodiment of the present disclosure provides a base station.

In some embodiments, the fault processing device includes: one or more processors and one or more memories. FIG. 8 uses one processor and one memory as an example. The processor and the memory may be connected with each other by a bus or in other ways. Connection by a bus is used as an example in FIG. 8.

The memory, as a non-transitory computer-readable storage medium, may be configured to store a non-transitory software program and a non-transitory computer-executable program, for example, the fault processing method in the embodiments of the present disclosure. The processor executes the non-transitory software program and the non-transitory computer-executable program stored in the memory, to implement the fault processing method in the embodiments of the present disclosure.

The memory may include a program storage area and a data storage area. The program storage area may store an operating system, and an application required by at least one function. The data storage area may store data and the like required for executing the fault processing method in the embodiments of the present disclosure. In addition, the memory may include a high-speed random access memory, and may also include a non-transitory memory, e.g., at least one magnetic disk storage device, flash memory device, or other non-transitory solid-state storage device. In some implementations, the memory may include a memory located remotely from the processor, and the remote memory may be connected to the fault processing device via a network. Examples of the network include, but not limited to, the Internet, an intranet, a local area network, a mobile communication network, and combinations thereof.

The non-transitory software program and the non-transitory computer-executable program required for implementing the fault processing method in the embodiments of the present disclosure are stored in the memory which, when executed by one or more processors, cause the one or more processors to implement the fault processing method in the embodiments of the present disclosure, for example, implement the steps S101 to S104 in FIG. 1, the steps S201 to S202 in FIG. 2, the steps S301 to S303 in FIG. 3, the steps S401 to S402 in FIG. 4, the steps S501 to S502 in FIG. 5, or the steps S601 to S605 in FIG. 6, including: acquiring an alarm type of a chip, where the alarm type includes an alarm indicating that a fault of the chip is self-repairable and an alarm indicating that the fault of the chip is not self-repairable; when it is determined that the alarm type indicates that the fault of the chip is not self-repairable, retrieving a historical alarm identifier of the chip; when it is identified that a historical alarm identifier of the chip is present for N times, executing a preset self-repair process, where N is an integer greater than or equal to 1; when the chip is still in an abnormal state after the self-repair process has been executed M times, determining whether a transceiver system meets a system reset requirement, where M is an integer greater than or equal to 1; and when the transceiver system meets the system reset requirement, starting a system reset operation to repair the fault of the chip. Based on this, the present disclosure can intelligently implement fault information detection and fault recovery while minimizing the impact on normal operation of the transceiver system, providing effective information for engineers to analyze faults. The present disclosure has the advantages of high accuracy of fault information and short fault recovery time, thereby improving the timeliness of product fault correction. The present disclosure can achieve intelligent operation and maintenance during the use of the transceiver system, improve production and maintenance efficiency, shorten the impact of the fault, and reduce labor costs for maintenance.

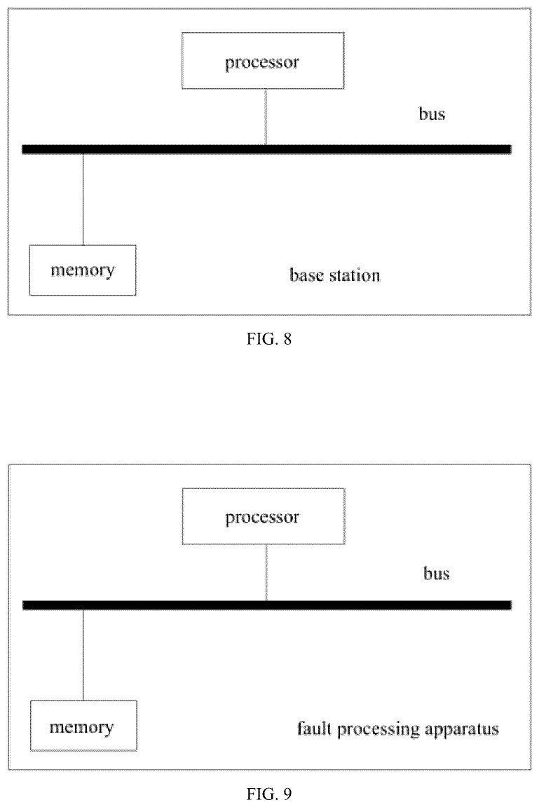

As shown in FIG. 9, an embodiment of the present disclosure provides a fault processing device.

In some embodiments, the fault processing device includes one or more processors and one or more memories. FIG. 9 uses one processor and one memory as an example. The processor and the memory may be connected with each other by a bus or in other ways. Connection by a bus is used as an example in FIG. 9.

The memory, as a non-transitory computer-readable storage medium, may be configured to store a non-transitory software program and a non-transitory computer-executable program, for example, the fault processing method in the embodiments of the present disclosure. The processor executes the non-transitory software program and the non-transitory computer-executable program stored in the memory, to implement the fault processing method in the embodiments of the present disclosure.

The memory may include a program storage area and a data storage area. The program storage area may store an operating system, and an application required by at least one function. The data storage area may store data and the like required for executing the fault processing method in the embodiments of the present disclosure. In addition, the memory may include a high-speed random access memory, and may also include a non-transitory memory, e.g., at least one magnetic disk storage device, flash memory device, or other non-transitory solid-state storage device. In some implementations, the memory may include a memory located remotely from the processor, and the remote memory may be connected to the fault processing device via a network. Examples of the network include, but not limited to, the Internet, an intranet, a local area network, a mobile communication network, and combinations thereof.

The non-transitory software program and the non-transitory computer-executable program required for implementing the fault processing method in the embodiments of the present disclosure are stored in the memory which, when executed by one or more processors, cause the one or more processors to implement the fault processing method in the embodiments of the present disclosure, for example, implement the steps S101 to S104 in FIG. 1, the steps S201 to S202 in FIG. 2, the steps S301 to S303 in FIG. 3, the steps S401 to S402 in FIG. 4, the steps S501 to S502 in FIG. 5, or the steps S601 to S605 in FIG. 6, including: acquiring an alarm type of a chip, where the alarm type includes an alarm indicating that a fault of the chip is self-repairable and an alarm indicating that the fault of the chip is not self-repairable; when it is determined that the alarm type indicates that the fault of the chip is not self-repairable, retrieving a historical alarm identifier of the chip; when it is identified that a historical alarm identifier of the chip is present for N times, executing a preset self-repair process, where N is an integer greater than or equal to 1; when the chip is still in an abnormal state after the self-repair process has been executed M times, determining whether a transceiver system meets a system reset requirement, where M is an integer greater than or equal to 1; and when the transceiver system meets the system reset requirement, starting a system reset operation to repair the fault of the chip. Based on this, the present disclosure can intelligently implement fault information detection and fault recovery while minimizing the impact on normal operation of the transceiver system, providing effective information for engineers to analyze faults. The present disclosure has the advantages of high accuracy of fault information and short fault recovery time, thereby improving the timeliness of product fault correction. The present disclosure can achieve intelligent operation and maintenance during the use of the transceiver system, improve production and maintenance efficiency, shorten the impact of the fault, and reduce labor costs for maintenance.

In addition, an embodiment of the present disclosure provides a computer-readable storage medium, storing a computer-executable program. The computer-executable program, when executed by one or more control processors, for example, a processor in FIG. 8, may cause the one or more processors to implement the fault processing method in the embodiments of the present disclosure, for example, implement the steps S101 to S104 in FIG. 1, the steps S201 to S202 in FIG. 2, the steps S301 to S303 in FIG. 3, the steps S401 to S402 in FIG. 4, the steps S501 to S502 in FIG. 5, or the steps S601 to S605 in FIG. 6, including: acquiring an alarm type of a chip, where the alarm type includes an alarm indicating that a fault of the chip is self-repairable and an alarm indicating that the fault of the chip is not self-repairable; when the alarm type indicates that the fault of the chip is not self-repairable, retrieving a historical alarm identifier of the chip, and when it is identified that a historical alarm identifier of the chip is present for N times, executing a preset self-repair process, where N is an integer greater than or equal to 1; when the chip is still in an abnormal state after the self-repair process has been executed M times, determining whether a transceiver system meets a system reset requirement, where M is an integer greater than or equal to 1; and when the transceiver system meets the system reset requirement, starting a system reset operation to repair the fault of the chip. Based on this, the present disclosure can intelligently implement fault information detection and fault recovery while minimizing the impact on normal operation of the transceiver system, providing effective information for engineers to analyze faults. The present disclosure has the advantages of high accuracy of fault information and short fault recovery time, thereby improving the timeliness of product fault correction. The present disclosure can achieve intelligent operation and maintenance during the use of the transceiver system, improve production and maintenance efficiency, shorten the impact of the fault, and reduce labor costs for maintenance.

Those having ordinary skills in the art can understand that all or some of the steps in the methods disclosed above and the system can be implemented as software, firmware, hardware, and appropriate combinations thereof. Some or all physical components may be implemented as software executed by a processor, such as central processing unit, digital signal processor, or microprocessor, or as hardware, or as an integrated circuit, such as an application-specific integrated circuit. Such software may be distributed on a computer-readable medium, which may include a computer storage medium (or non-transitory medium) and a communication medium (or transitory medium). As well known to those having ordinary skills in the art, the term “computer storage medium” includes volatile and nonvolatile, removable and non-removable media implemented in any method or technology for storage of information (such as a computer-readable program, data structures, program modules, or other data). The computer storage medium includes, but not limited to, Random Access Memory (RAM), Read-Only Memory (ROM), Electrically Erasable Programmable Read-Only Memory (EEPROM), flash memory or other memory technology, Compact Disc Read-Only Memory (CD-ROM), Digital Versatile Disc (DVD) or other optical storage, cassette, magnetic tape, magnetic disk storage or other magnetic storage device, or any other medium which can be used to store the desired information and can be accessed by a computer. In addition, as well known to those having ordinary skills in the art, the communication medium typically includes a computer-readable program, data structures, program modules, or other data in a modulated data signal such as a carrier or other transport mechanism, and can include any information delivery medium.

Although some embodiments of the present disclosure have been described above, the present disclosure is not limited to the implementations described above. Those having ordinary skills in the art can make various equivalent modifications or replacements without departing from the scope of the present disclosure. Such equivalent modifications or replacements fall within the scope defined by the claims of the present disclosure

1. A fault processing method, applied to a transceiver system comprising a chip, the method comprising:
acquiring an alarm type of a chip, wherein the alarm type comprises an alarm indicating that a fault of the chip is self-repairable and an alarm indicating that the fault of the chip is not self-repairable;
in response to determining that the alarm type indicates that the fault of the chip is not self-repairable, retrieving a historical alarm identifier of the chip, and in response to identifying that a historical alarm identifier of the chip is present for N times, executing a preset self-repair process, wherein N is an integer greater than or equal to 1;
in response to determining that the chip is still in an abnormal state after the self-repair process has been executed M times, determining whether a transceiver system meets a system reset requirement, wherein M is an integer greater than or equal to 1; and
in response to the transceiver system meeting the system reset requirement, starting a system reset operation to repair the fault of the chip.

2. The method of claim 1, further comprising:
self-repairing the fault of the chip in response to determining that the alarm type indicates that the fault of the chip is self-repairable.

3. The method of claim 1, wherein acquiring an alarm type of a chip comprises:
acquiring an alarm state of the chip; and
determining the alarm type of the chip according to the alarm state.

4. The method of claim 3, wherein after determining the alarm type of the chip according to the alarm state, the method further comprises:
determining an alarm identifier according to the alarm type of the chip, wherein the alarm identifier comprises a first alarm identifier configured to indicate that the fault of the chip is self-repairable, and a second alarm identifier configured to indicate that the fault of the chip is not self-repairable;
in response to determining that the alarm identifier is the first alarm identifier, self-repairing, by the chip, the fault of the chip; and
in response to determining that the alarm identifier is the second alarm identifier, saving an operational status information of the chip, and sending, by the chip, the second alarm identifier to the transceiver system.

5. The method of claim 4, wherein self-repairing, by the chip, the fault of the chip comprises:
in response to determining that a transmit power of the chip exceeds a preset threshold, decreasing the transmit power to a first set value, and latching the first alarm identifier; and
in response to determining that the first alarm identifier has disappeared, changing the transmit power back to a second set value to restore the transmit power.

6. The method of claim 1, wherein after retrieving a historical alarm identifier of the chip, the method further comprises:
saving black box information of the chip; and
clearing the historical alarm identifier of the chip, and retrieving the historical alarm identifier in the chip again.

7. The method of claim 1, wherein determining that the transceiver system meets the system reset requirement in response to:
the transceiver system being in a low-traffic operating state; or
the transceiver system receiving a sleep operation instruction.

8. The method of claim 1, wherein after the transceiver system meets the system reset requirement, the method further comprises:
acquiring fault information of the transceiver system;
determining a fault type according to the fault information;
executing a corresponding fault diagnosis process according to the fault type;
saving a fault diagnosis log during the execution of the fault diagnosis process; and
outputting a fault diagnosis report according to the fault diagnosis process.

9. A base station, comprising:
a memory, a processor, and a computer program stored in the memory and executable by the processor, wherein the computer program, when executed by the processor, causes the processor to perform a fault processing method applied to a transceiver system comprising a chip, the method comprising:
acquiring an alarm type of a chip, wherein the alarm type comprises an alarm indicating that a fault of the chip is self-repairable and an alarm indicating that the fault of the chip is not self-repairable;
in response to determining that the alarm type indicates that the fault of the chip is not self-repairable, retrieving a historical alarm identifier of the chip, and in response to identifying that a historical alarm identifier of the chip is present for N times, executing a preset self-repair process, wherein N is an integer greater than or equal to 1;
in response to determining that the chip is still in an abnormal state after the self-repair process has been executed M times, determining whether a transceiver system meets a system reset requirement, wherein M is an integer greater than or equal to 1; and
in response to the transceiver system meeting the system reset requirement, starting a system reset operation to repair the fault of the chip.

10. (canceled)

11. A computer-readable storage medium, storing a computer-executable program which, when executed by a computer, causes the computer to perform a fault processing method applied to a transceiver system comprising a chip, the method comprising:
acquiring an alarm type of a chip, wherein the alarm type comprises an alarm indicating that a fault of the chip is self-repairable and an alarm indicating that the fault of the chip is not self-repairable;
in response to determining that the alarm type indicates that the fault of the chip is not self-repairable, retrieving a historical alarm identifier of the chip, and in response to identifying that a historical alarm identifier of the chip is present for N times, executing a preset self-repair process, wherein N is an integer greater than or equal to 1;
in response to determining that the chip is still in an abnormal state after the self-repair process has been executed M times, determining whether a transceiver system meets a system reset requirement, wherein M is an integer greater than or equal to 1; and
in response to the transceiver system meeting the system reset requirement, starting a system reset operation to repair the fault of the chip.

12. The base station of claim 9, wherein the method further comprises:
self-repairing the fault of the chip in response to determining that the alarm type indicates that the fault of the chip is self-repairable.

13. The base station of claim 9, wherein acquiring an alarm type of a chip comprises:
acquiring an alarm state of the chip; and
determining the alarm type of the chip according to the alarm state.

14. The base station of claim 13, wherein after determining the alarm type of the chip according to the alarm state, the method further comprises:
determining an alarm identifier according to the alarm type of the chip, wherein the alarm identifier comprises a first alarm identifier configured to indicate that the fault of the chip is self-repairable, and a second alarm identifier configured to indicate that the fault of the chip is not self-repairable;
in response to determining that the alarm identifier is the first alarm identifier, self-repairing, by the chip, the fault of the chip; and
in response to determining that the alarm identifier is the second alarm identifier, saving an operational status information of the chip, and sending, by the chip, the second alarm identifier to the transceiver system.

15. The base station of claim 14, wherein self-repairing, by the chip, the fault of the chip comprises:
in response to determining that a transmit power of the chip exceeds a preset threshold, decreasing the transmit power to a first set value, and latching the first alarm identifier; and
in response to determining that the first alarm identifier has disappeared, changing the transmit power back to a second set value to restore the transmit power.

16. The base station of claim 9, wherein after retrieving a historical alarm identifier of the chip, the method further comprises:
saving black box information of the chip; and
clearing the historical alarm identifier of the chip, and retrieving the historical alarm identifier in the chip again.

17. The computer-readable storage medium of claim 11, wherein the method further comprises:
self-repairing the fault of the chip in response to determining that the alarm type indicates that the fault of the chip is self-repairable.

18. The computer-readable storage medium of claim 11, wherein acquiring an alarm type of a chip comprises:
acquiring an alarm state of the chip; and
determining the alarm type of the chip according to the alarm state.

19. The computer-readable storage medium of claim 18, wherein after determining the alarm type of the chip according to the alarm state, the method further comprises:
determining an alarm identifier according to the alarm type of the chip, wherein the alarm identifier comprises a first alarm identifier configured to indicate that the fault of the chip is self-repairable, and a second alarm identifier configured to indicate that the fault of the chip is not self-repairable;
in response to determining that the alarm identifier is the first alarm identifier, self-repairing, by the chip, the fault of the chip; and
in response to determining that the alarm identifier is the second alarm identifier, saving an operational status information of the chip, and sending, by the chip, the second alarm identifier to the transceiver system.

20. The computer-readable storage medium of claim 19, wherein self-repairing, by the chip, the fault of the chip comprises:
in response to determining that a transmit power of the chip exceeds a preset threshold, decreasing the transmit power to a first set value, and latching the first alarm identifier; and
in response to determining that the first alarm identifier has disappeared, changing the transmit power back to a second set value to restore the transmit power.

21. The computer-readable storage medium of claim 11, wherein after retrieving a historical alarm identifier of the chip, the method further comprises:
saving black box information of the chip; and
clearing the historical alarm identifier of the chip, and retrieving the historical alarm identifier in the chip again.
